(19) United States
(12) Patent Application Publication
(10) Pub. No.: US 2005/0081151 A1
(43) Pub. Date: Apr. 14, 2005

(54) Method and computer program to determine compliance with export requirements

(76) Inventor: Johannes Wilhelmus Van Der Meer, Houston, TX (US)

Correspondence Address: Eugene R. Montalvo;Shell Oil Company, Legal - Intellectual Property, P.O. Box 2463, Houston, TX, 77252-2463, US

(21) Appl. No.: 10/925,673

(22) Filed: Aug. 25, 2004

Related U.S. Application Data
(60) Provisional application No. 60/497,759, filed on Aug. 26, 2003.

(51) Int. Cl. G06F 3/00

(52) U.S. Cl. 715/700

(57) ABSTRACT

A method is provided for automatic preparation of displays containing requirements for compliance with export restrictions for a set of exportable elements. The method includes the steps of: compiling an inventory of the exportable elements with applicable criteria for control identified for each exportable element; obtaining a digital matrix of a plurality of destinations containing control criteria for each destination; and automatically, using a computer, comparing criteria for control for each exportable element with control criteria for a plurality of countries and preparing a display, selected from the group consisting of a display for each country with applicable restrictions for each of the exportable elements for which restrictions apply to that destination, a display for at least one exportable element that includes destination for which restrictions apply, and both of the preceding displays.

### FIELD OF THE INVENTION

The present invention relates to computer programs and methods to establish displays useful in determining compliance with export control regulations and to apparatuses useful in practicing these methods.

### BACKGROUND TO THE INVENTION

The government of the United States of America regulates export of commodities, software and technical data by a set of regulations to further various policies of the government. Details of these regulations change on a regular basis, but the general format of the restrictions have remained constant for many decades. Codes called ECCN numbers are assigned to commodities, software and technical data, and restrictions on exports (or requirements to obtain an export license) are defined for each of these codes. The portion of the Export Regulations that define ECCNs for commodities and technical data are found in 15 C.F.R. 774, Supplement 1. This supplement defines material that falls within each ECCN, and then provides a list of “reasons for control” for subject matter within the ECCN. Reasons for control applicable for each country are listed in a Commerce Country Chart, which is found in 15 C.F.R. 738Spir. If a “reason for control” applicable for a ECCN is listed in the Commerce Country Chart for a particular country, then restrictions apply to export of items falling within that ECCN to that country. The Commerce Country Chart can be downloaded from a web site of the Bureau of Industry and Security of the U.S. Department of Commerce.

Part 738 of the export regulation describes how the Commerce Country Chart and Supplement 1 for 15 C.F.R. 774 are used to determine if an export license is required for a commodity or technical data. These regulations are occasionally modified as policies and events dictate changing national interests.

Various web sites can be found that offer services and tools to aid in compliance with the US export regulations. But none of these tools and services eliminate a need to manually compare the Commerce Country Chart with the reasons for control applicable to items within a particular ECCN.

### SUMMARY OF THE INVENTION

A method is provided for automatic preparation of displays containing requirements for compliance with export restrictions for a set of exportable elements, the method comprising the steps of: compiling an inventory of the exportable elements with applicable criteria for control identified for each exportable element; obtaining a digital matrix of a plurality of destinations containing control criteria for each destination; and automatically, using a computer, comparing criteria for control for each exportable element with control criteria for a plurality of countries and preparing a display selected from the group consisting of a display for each country with applicable restrictions for each of the exportable elements for which restrictions apply to that country, a display for at least one exportable element that includes destination for which restrictions apply, and both of the preceding displays.

The present method takes advantage of downloadable information from a web site provided by the US Department of Commerce, and combines this information with information related to an inventory of exportable items maintained by an organization. Displays created are useful for reference by individuals within the organization who may not be intimately familiar with complex export regulations, but who benefit from having information available organized by destination or by product to make day to day operating decisions.

### DESCRIPTION OF AN EMBODIMENT

Current US export regulations define things that are controlled as commodities, technical data, or software. Controlled items are identified by ECCN numbers. Nomenclature could differ, but the present invention utilizes some categorization of exportable elements. Rules applicable for each ECCN number are then described in the regulations. “Reasons for control” are used to generalize treatment of categories of commodities, technical data and software. Codes for “reasons for control” are listed for each ECCN number, and rules that apply to those “reasons for control” are described in the regulations. The present invention applies to this system, but is also more general, and will apply to other systems that organized other systems.

An organization that supplies products to customers will usually know ECCN numbers of each product offered in order to comply with US export regulations. An organization that operates globally will also typically know what ECCN number applies to different types of technical information that may be communicated to non-citizens of the United States of America, or otherwise treat in a way that would be considered by the US export regulations to be an export or reexport of that technical information. A list of such commodities, software and/or technical data is referred to herein as and inventory of exportable elements. Such an inventory will typically include an ECCN number for identification, and a description of the items or types of items in that item of the inventory.

Destinations to which exports are sent are typically countries, but the export regulations may include restrictions that are not just countries. Thus a destination is not limited to being a country, but could also be, for example, an organization, region, or a government entity.

Currently, US export regulations, supplement 1 to part 774 includes a definition of what falls within each ECCN number, and a list of “reasons for control” applicable to that ECCN number. The “reasons for control” are an example of what is herein referred to as control criteria. The regulations change from time to time, and the “reasons for control” could easily be changed to some other criteria that would be applicable as a criteria to dictate a level of control for that ECCN number. The current system within the US Export Regulations states “reasons for control” in a Commerce Country Chart, and if a “reason for control” is applicable to the country. If the “reason for control” is applicable for that country, then generally, a license is needed to export to that country an item that falls within ECCN numbers that have that “reason for control” applicable to it.

Control criteria for each country could be obtained from a US Department of Commerce web sites. At the time of this application, the web site is http://www.access.gpo.gov/bis/ear/ear data.html, but may be changed from time to time as a result of changes in the website. The website address within the module may be changed to accommodate these changes. This information may be downloaded and downloaded information could be modified to a format or appearance to better suit the purposes of the present invention. This modification could be performed manually or automatically. After initially downloading the criteria for control, the criteria for control for each exportable element may be kept current manually by updates based on changes to Supplement 1 to part 774 of the US Export Regulations. It could be advantageous to perform these updates automatically, but this step could also be performed manually.

After an inventory of exportable elements with applicable criteria for control identified for each element, and a digital matrix of reasons for control for at least some destinations are provided, this information may be automatically combined to provide displays that are useful to provide guidance about export control requirements. By automatically comparing criteria for export, it is intended that the process could be initiated manually. Further, it may be desirable to manually supply and review the input to a computer and then have the computer automatically compare criteria for export and compile useful outputs.

It may be desirable to provide readily available guidance to at least some individuals organized by product. For other purposes, the same information organized by destination may be more useful. In one embodiment of the present invention, the system may prepare outputs in different formats. One format would be to arrange restrictions that apply to the inventory of exportable elements together for each destination. Alternatively, for example, a page of a summary of each exportable element from the inventory could be made for each country to which exports are restricted. In another embodiment, a user may be provided with options for the format of output.

Displays could include groupings of exportable elements or groupings of countries to the extent such groupings make the final product more useful. For example, regions of a country, or certain organizations within a country may have different restrictions. But it may also be convenient to organize information about export requirements into web pages, or printed books, that have the information organized by country. Keeping an organized set of information current could be an administrative burden. It would therefore be useful to have such information organized in such a way that an update could be prepared using a computer to compile an updated set of information.

The update could be made often, for example, every time information is requested from the system. The update also does not have to be a complete update. For example, if information about a particular exportable element is requested, or information about a particular destination, then just that element or destination could be updated. Also, source matrixes could be checked to determine if they have changed, and if no changes have been made, then the information could be used directly.

In an embodiment of the present invention a spreadsheet may utilize commercially available software including:
a) MsExcel (with macros and VB enabled) as main controlling module,
b) MsWord (with macros and VB enabled) as editing template,
c) Internet Explorer, to connect to the world wide web,
d) Acrobat Distiller, to convert output to pdf format.

The program may have three distinct modules that are described in more detail below.
1. Refresh of the Commerce Country Chart from the BIS website.

From a main module in Excel an MsWord template is launched that, using Internet Explorer, downloading a latest available version of the Commerce Country Chart (CCC) in a format that can be read and converted by MsWord. The WordPerfect format is selected for that purpose.

The downloaded CCC file is stored in the same location on the computer as the main module and the template may be located, with the filename given on the BIS website. Macro's embedded in the template may then clean up the file and prepare it for transfer back to one of the worksheets in the main module, where it is compared with the running version of the CCC. By “cleaned up” it is meant that the format be converted to a format that is more useful in an Excel spreadsheet, for example by removing spaces and unneeded words.

Automatic color-coding in the current version of the CCC highlight the cells where the current version of the CCC differs from the just downloaded version. Corrections may be made manually to ensure that at the same time the impact on the business of that change will be assessed and addressed.

The date of the last update may be updated for future reference in the main screen.
This module assumes:
   a) The BIS website is at http://w3.access.gpo.gov/bis/ear/ear_data.html
   b) The file to be downloaded is called 738spir.wpd
   c) Internet Explorer version 5 or later is available As noted above, the specific web site and/or document name may be changed from time to time within the module to track changes in government website organization and file naming.
2. Creation of output files with controlled technologies per country.

A second module may create a set of output files, either electronic or on paper, that show all technologies that are controlled to each of the countries listed in the CCC. For each country in the CCC a list of reasons for control is given, while in the controlled technology list (“CT-List”) for each technology the reason for control is given based on information provided to the inventories of exportable elements.

Macros and VB code may be used to combine this CT-List with the selected country, based on the reason for control. Logic applied to the CT-List marks all those technologies that have a reason for control applicable to the selected country, extracts them to a new sheet and reformat the sheet to produce a usable output. Output files may be produced in Excel and, based on user selection, may be printed or stored electronically in pdf format. The output may be produced for one or multiple countries based on user selection.
3. Creation of output files with countries to which a technology is controlled.

A third module may create an overview of all countries to which a selected technology is controlled. The user may select an ECCN number of the selected technology from, for example, drop down boxes that are populated from the CT-List. Upon completion of the selection, automatically all countries may show up to which that ECCN is controlled. The output file can be printed or saved in pdf format and may include the full detail of the technology/ies linked to that ECCN, the reasons for control and the countries to which it is controlled.

An exemplary spreadsheet may have four sheets. The first sheet could be a cover sheet with a format that include buttons programmed to perform macros when clicked on in order to execute various steps of the invention, and to configure outputs according to a user's needs. Inventories of exportable technology and/or technologies may be stored in sheet 2. Sheet 3 could be a table of all ECCNs with restrictions described for each ECCN, and an overview of all countries to which a technology with the selected ECCN is controlled. Different or additional tables could be stored in this sheet, or the tables could be divided among different sheets. The object of this sheet is to provide a place for calculated tables designed to provide information combined from the inventories and the Commerce Country Chart. The forth sheet may be the downloaded and optionally “cleaned up” Commerce Country Chart from the BIS website.

Export regulations are frequently changing and there are many other aspects of the regulations that need to be complied with. This tool is therefore not intended to be a substitute for competent legal advice.

1. A method for automatic preparation of displays containing requirements for compliance with export restrictions for a set of exportable elements, the method comprising the steps of:
compiling an inventory of the exportable elements with applicable criteria for control identified for each exportable element;
obtaining a digital matrix of a plurality of destinations containing control criteria for each destination; and
automatically, using a computer, comparing criteria for control for each exportable element with control criteria for a plurality of countries and preparing a display selected from the group consisting of a display for each country with applicable restrictions for each of the exportable elements for which restrictions apply to that destination, a display for at least one exportable element that includes destination for which restrictions apply, and both of the preceding displays.

2. The method of claim 1 wherein the inventory comprises a list of a plurality of elements with reasons for control identified for each element.

3. The method of claim 1 wherein country destination and control criteria are downloaded from an internet server.

4. The method of claim 1 wherein the displays of applicable restrictions for each country are stored on a network server.

5. The method of claim 1 wherein the displays of applicable restrictions for each country are stored on an internet server.

6. The method of claim 1 wherein the displays of applicable restrictions for each country are printed and compiled for reference.

7. The method of claim 1 wherein the exportable elements comprises commodities.

8. The method of claim 1 wherein the exportable element comprises categories of technical data.

9. The method of claim 1 wherein the inventory of exportable elements includes commodities and technical data wherein the technical data is divided into categories.

10. The method of claim 7 wherein each commodity is assigned an ECCN number.

11. The method of claim 8 wherein each category of technical data is assigned an ECCN number

12. The method of claim 7 wherein each commodity is assigned a set of reasons for control.

13. The method of claim 8 wherein each category of technical data is assigned a set of reasons for control.

14. The method of claim 10 wherein the reasons for control are obtained from export regulations.

15. A system, comprising:
a CPU;
a data memory coupled to the CPU; and
a system memory coupled to the CPU, wherein the system memory is configured to store one or more computer programs executable by the CPU, and wherein the computer programs are executable to implement a method of automatic preparation of displays containing requirements for compliance with export restrictions for a set of exportable elements, using a computer system, the method comprising the steps of:
compiling an inventory of the exportable elements with applicable criteria for control identified for each exportable element;
obtaining a digital matrix of a plurality of destinations containing control criteria for each destination; and
automatically, using a computer, comparing criteria for control for each exportable element with control criteria for a plurality of countries and preparing a display selected from the group consisting of a display for each country with applicable restrictions for each of the exportable elements for which restrictions apply to that destination, a display for at least one exportable element that includes destination for which restrictions apply, and both of the preceding displays.

16. The system of claim 15 wherein the inventory comprises a list of a plurality of elements with reasons for control identified for each element.

17. The system of claim 15 wherein country destination and control criteria are downloaded from an internet server.

18. The system of claim 15 wherein the displays of applicable restrictions for each country are stored on a network server.

19. The system of claim 15 wherein the displays of applicable restrictions for each country are stored on an internet server.

20. The system of claim 15 wherein the displays of applicable restrictions for each country are printed and compiled for reference.

21. The system of claim 15 wherein the exportable elements comprises commodities.

22. The system of claim 15 wherein the exportable element comprises categories of technical data.

23. The system of claim 15 wherein the inventory of exportable elements includes commodities and technical data wherein the technical data is divided into categories.

24. The system of claim 15 wherein each commodity is assigned an ECCN number.

25. The system of claim 22 wherein each category of technical data is assigned an ECCN number

26. The system of claim 21 wherein each commodity is assigned a set of reasons for control.

27. The system of claim 22 wherein each category of technical data is assigned a set of reasons for control.

28. The system of claim 25 wherein the reasons for control are obtained from export regulations.

29. A carrier medium comprising program instructions, wherein the program instructions are computer-executable to implement a method comprising:
compiling an inventory of the exportable elements with applicable criteria for control identified for each exportable element;
obtaining a digital matrix of a plurality of destinations containing control criteria for each destination; and
automatically, using a computer, comparing criteria for control for each exportable element with control criteria for a plurality of countries and preparing a display selected from the group consisting of a display for each country with applicable restrictions for each of the exportable elements for which restrictions apply to that destination, a display for at least one exportable element that includes destination for which restrictions apply, and both of the preceding displays.

30. A monitor displaying information created by the steps of:
compiling an inventory of the exportable elements with applicable criteria for control identified for each exportable element;
obtaining a digital matrix of a plurality of destinations containing control criteria for each destination; and
automatically, using a computer, comparing criteria for control for each exportable element with control criteria for a plurality of countries and preparing a display selected from the group consisting of a display for each country with applicable restrictions for each of the exportable elements for which restrictions apply to that destination, a display for at least one exportable element that includes destination for which restrictions apply, and both of the preceding displays.
